(19) United States
(12) Patent Application Publication
(10) Pub. No.: US 2007/0160054 A1
(43) Pub. Date: Jul. 12, 2007

(54) Method and system for receiving call center feedback

(75) Inventors: Shmuel Shaffer, Palo Alto, CA (US); Labhesh Patel, San Francisco, CA (US); Denise G. Caballero-McCann, Raleigh, NC (US); Joseph F. Khouri, San Jose, CA (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/330,727

(22) Filed: Jan. 11, 2006

(51) Int. Cl. H04L 12/56; H04J 3/14

(52) U.S. Cl. 370/395.2; 370/249

(57) ABSTRACT

A method for receiving feedback at a call center includes receiving a call from a caller for connection with one of a plurality of agents and distributing the call to a first agent of the plurality of agents. The method includes initiating a first communication session with the caller and the first agent to handle the call. The method also includes initiating a second communication session with the caller. The second communication session comprises a feedback session parallel to the first communication session. The method also includes receiving from the caller feedback relating to the first communication session between the caller and the first agent.

### BACKGROUND OF THE INVENTION

Automatic call distributors (ACDs) and call centers, or other contact centers typically include systems designed to match incoming requests for service, for example a telephone call or an e-mail, with a resource that is able to provide that service, such as a human call center agent. ACDs generally perform one or more of the following functions: (i) recognize and answer incoming calls; (ii) review database(s) for instructions on what to do with a particular call; (iii) using these instructions, identify an appropriate agent and queue the call, often times providing a prerecorded message; and (iv) connect the call to an agent as soon as the agent is available.

Call centers continuously strive to improve customer satisfaction by soliciting caller feedback to meet their service level commitments. Many call centers employ numerous post-call feedback mechanisms. For example, a recent caller may be sent a questionnaire inquiring about the quality of service provided by the call center. The resulting feedback may, however, be skewed by the type of customer that is motivated to answer the questionnaires. In another example, after resolving a caller's issue, an agent may ask the caller if she would be willing to spend a brief period of time to provide feedback regarding the service she received. In this case, the agent may influence the feedback results by selecting for feedback only those customers who were satisfied with the service provided. In either case, feedback is collected after the call. Post-call feedback may improve the level of service of the call center in the long run but cannot improve the satisfaction or dissatisfaction on the call that is currently being served.

Some work has been done to develop systems that receive feedback by analyzing speech recognition with an attempt to identify callers who are angry or are in distress. However, some callers may sound distressed due to reasons unrelated to the level of service. For example, a caller who calls a hospital may exhibit stress because of an illness of a loved one and not because of the service they are being provided. Systems like these sometimes use faulty metrics, such as voice stress levels, to gage satisfaction, which may falsely trigger action from the call center and waste call center resources.

### SUMMARY OF THE INVENTION

The present invention provides a method and system for receiving feedback at call centers that substantially eliminates or reduces at least some of the disadvantages and problems associated with previous methods and systems.

In accordance with a particular embodiment, a method for receiving feedback at a call center includes receiving a call from a caller for connection with one of a plurality of agents and distributing the call to a first agent of the plurality of agents. The method includes initiating a first communication session with the caller and the first agent to handle the call and initiating a second communication session with the caller. The second communication session comprises a feedback session parallel to the first communication session. The method also includes receiving from the caller feedback relating to the first communication session between the caller and the first agent. In another embodiment, the method also includes sending the feedback relating to the first communication session to the first agent. The feedback session may comprise a voice, dual-tone multi-frequency (DTMF), web, and/or instant messaging session.

The method may also include prompting the caller in the first communication session for feedback. The method may also include detecting that an endpoint of the caller is multi-media enabled, determining a set of multi-media capabilities of the endpoint, and initiating the first communication session and the second communication session using multimedia connections compatible with the set of multi-media capabilities of the endpoint.

The method may also include determining that the received feedback falls below a predetermined satisfaction threshold. In response to the determining that the received feedback falls below a predetermined satisfaction threshold, the method may include notifying a supervisor that the received feedback falls below the predetermined satisfaction threshold, initiating a communication session with a supervisor to monitor the call, transferring the call from the first agent to a supervisor, or recording the first session for evaluation.

In accordance with another embodiment, a system for receiving call center feedback includes an interface operable to receive a call from a caller for connection with one of a plurality of agents. The system also includes a processor operable to initiate a first communication session with the caller and a first agent to handle the call and initiate a second communication session with the caller. The second communication session comprises a feedback session parallel to the first communication session. The interface is further operable to receive from the caller feedback relating to the first communication session between the caller and the first agent.

Technical advantages of particular embodiments include methods and systems for receiving call center feedback that provide feedback during a feedback session between a caller and, for example, a feedback manager. This feedback session runs parallel to the communication session between the caller and the agent handling the call. If the feedback falls below a pre-determined satisfaction threshold, a notification event may be created which could trigger an action such as supervisor intervention or recording of one or both sessions. Feedback may be continuously processed as a score per agent and may be used to route calls to the highest scoring agents. This will reward agents with higher scores as well as resulting in higher customer satisfaction for callers. In addition, the parallel feedback session saves call center resources by eliminating the use of faulty metrics that may falsely trigger call center resources. Thus, the efficiency of the automatic call distribution system is improved as the call center receives effective feedback that will be used to immediately improve customer satisfaction to meet service level commitments.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 illustrates a communication system including a plurality of endpoints operable to communication among each other and a plurality of automatic call distributors, in accordance with a particular embodiment of the present invention;

FIG. 2 illustrates an automatic call distributor of FIG. 1 in more detail, illustrating aspects of the present invention; and

FIG. 3 illustrates a method for receiving and processing call center feedback, in accordance with particular embodiments of the present invention.

### DETAILED DESCRIPTION OF THE INVENTION

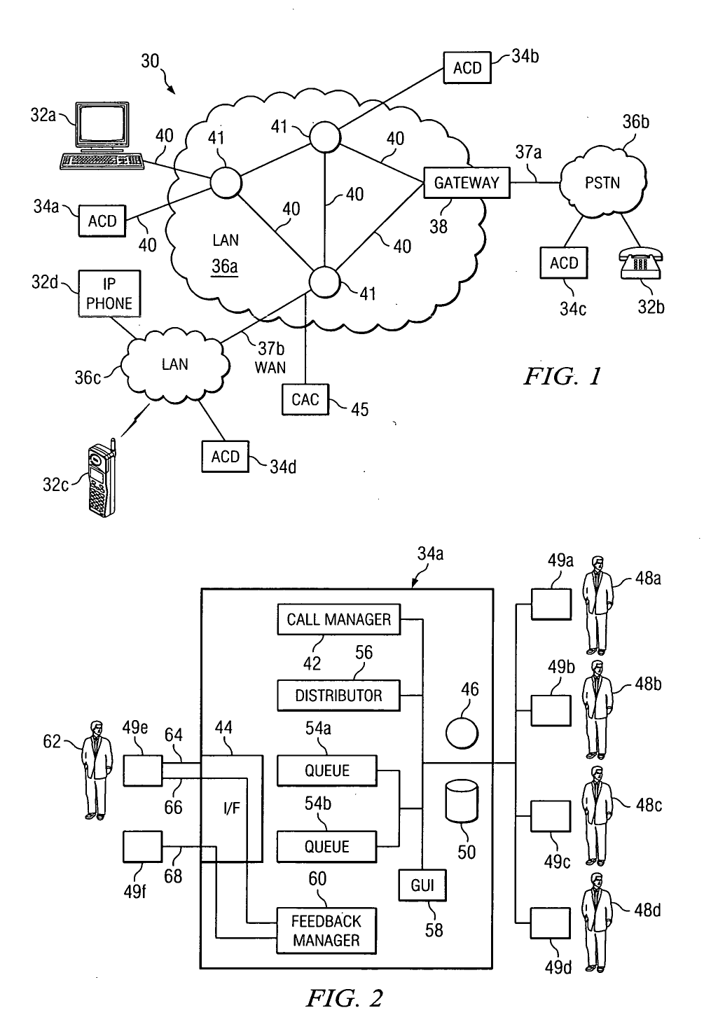

FIG. 1 illustrates a communication system 30 including a plurality of endpoints 32a-32d having the ability to establish communication sessions between each other and/or automatic call distributors (ACDs) 34a-34d, using one or more of communication networks 36a-36c. ACDs are specialized communication systems designed to route incoming calls to available agents, so that calls are properly and/or evenly distributed. For the purposes of this specification, “automatic call distributor” or “ACD” shall refer to any combination of hardware, software and/or embedded logic which is operable to automatically distribute incoming calls. ACDs may comprise hosted or non-hosted call centers. “Calls” shall include requests for service transmitted using any audio and/or video means, including signals, data or messages transmitted through voice devices, text chat, web sessions, facsimile, instant messaging (IM) and e-mail.

ACDs may include call centers or other contact centers that receive incoming customer calls for distribution to agents and that place calls to customers. Call centers may stand alone or be linked to other call centers, contact centers, or other computer networks. Call centers may be multi-media enabled. Multi-media call centers enable callers to interact with agents and supervisors using voice, video, e-mail, IM, web sharing, and other communication methods. A call center's ability to augment the voice interaction between agents and callers increases the productivity of the contact center. With the proliferation of session initiation protocol (SIP), the ability of call centers to support multi-media has been enhanced because SIP natively provides support for multi-media interactions. Furthermore, the availability of internet protocol (IP) telephone devices with large, user friendly screens allows applications to interact with end users more efficiently.

Call center services can sometimes be divided into two categories: “boiler room” services that handle a large number of calls and are measured by maximizing the number of calls per agent per hour and “platinum” services that provide a high touch personal service to cater to premium members. For example, a “platinum” service may provide high touch personal service where the most skilled agent available answers calls to ensure the best services to the premium callers. Some areas where this service would be very important are the financial sector, sales organizations, medical services, and organizations that depend heavily on high customer satisfaction. In this service environment the best agent may be answering all of the calls while less qualified agents may not be receiving any calls. In contrast, “boiler room” services handling large numbers of calls may treat agents as generic resources and calls are delivered to them by sequential algorithm. Many companies deploy both types of call center services.

In particular embodiments, the ACD system may improve both types of call center services. The ACD system may improve the level of customer satisfaction for the more lucrative part of business, the premium services. The ACD system may also reduce wasted resources used by boiler room services by eliminating the use of faulty feedback metrics such as voice stress levels and by supplementing the use of post-call feedback.

In particular embodiments, the ACD system provides a method of collecting customer feedback while the customer is still receiving service. Call centers may use this ACD system to provide a more transparent, dynamic feedback feature to their customers. By receiving feedback during the call, the ACD system may act upon the feedback immediately to improve the level of service while calls are still ongoing. The ACD system may create a feedback communication session that runs parallel to, or at the same time as, the original communication session between the caller and the agent. A feedback manager or other component may collect feedback from the caller in the feedback session regarding the agent's performance during the original communication session. In some embodiments, the feedback manager determines that the level of service falls below customer satisfaction goals, the original communication session may be recorded, terminated, interrupted, monitored, intercepted, and/or supervised. Thus, the ACD system is improved as feedback managers or other ACD components or personnel are informed of performance issues while the original communication session is ongoing. This gives the feedback manager an opportunity to immediately remedy performance issues thereby improving customer satisfaction to meet service level commitments.

In the illustrated embodiment, communication network 36a is a local area network (LAN) that enables communication between a plurality of endpoints 32a-32d and ACDs 34a-34d distributed across multiple cities and geographic regions. In another embodiment, a single, central ACD may be used, which distributes incoming calls to agents distributed across multiple cities and geographic regions. Communication network 36b is a public switched telephone network (PSTN) and couples endpoint 32b and ACD 34c with communication network 36a through gateway 38. Communication network 36c is another LAN, which couples endpoints 32c and 32d and ACD 34d with communication network 36a. Accordingly, users of endpoints 32a-32d and automatic call distributors 34a-34d can establish communication sessions between and among each network component coupled for communication with one or more of networks 36a-36c. Communication links 37a and 37b couple communication networks 36a and 36b, and communication networks 36a and 36c, respectively. In the illustrated embodiment, communication link 37b is a wide area network (WAN), which couples LANs 36a and 36c. A call admission control (CAC) system 45 may be used to monitor and police the bandwidth available over WAN 37b.

Communication network 36a includes a plurality of segments 40 and nodes 41 that couple endpoint 32a with ACDs 34a and 34b, gateway 38 and communication networks 36b-36c. Therefore, a user of endpoint 32a is provided with access to endpoints 32b-32d, and automatic call distributors 34a-34d. Nodes 41 may include any combination of network components, gatekeepers, call managers, conference bridges, routers, hubs, switches, gateways, endpoints, or other hardware, software, or embedded logic implementing any number of communication protocols that allow for the exchange of packets in communication system 30.

Although the illustrated embodiment includes three communication networks 36a-36c, the term “communication network” should be interpreted as generally defining any network capable of transmitting audio and/or video telecommunication signals, data, and/or messages, including signals, data or messages transmitted through text chat, instant messaging and e-mail. Any one of networks 36a-36c may be implemented as a local area network (LAN), wide area network (WAN), global distributed network such as the Internet, Intranet, Extranet, or any other form of wireless or wireline communication network. Generally, network 36a provides for the communication of packets, cells, frames, or other portions of information (generally referred to as packets herein) between endpoints 32a-32d. Communication network 36a may include any number and combination of segments 40, nodes 41, endpoints 32a-32d, and/or ACDs 34a-34d.

In a particular embodiment, communication network 36a employs voice communication protocols that allow for the addressing or identification of endpoints, nodes, and/or ACDs coupled to communication network 36a. For example, using internet protocol (IP), each of the components coupled together by communication network 36a in communication system 30 may be identified in information directed using IP addresses. In this manner, network 36a may support any form and/or combination of point-to-point, multicast, unicast, or other techniques for exchanging media packets among components in communication system 30. Any network components capable of exchanging audio, video, or other data using frames or packet, are included within the scope of the present invention.

Network 36a may be directly coupled to other IP networks including, but not limited to, another LAN or the Internet. Since IP networks share a common method of transmitting data, telecommunication signals may be transmitted between telephony devices located on different, but interconnected, IP networks. In addition to being coupled to other IP networks, communication network 36a may also be coupled to non-IP telecommunication networks through the use of interfaces or components, for example gateway 38. In the illustrated embodiment, communication network 36a is coupled with PSTN 36b through gateway 38. PSTN 36b includes switching stations, central offices, mobile telephone switching offices, pager switching offices, remote terminals, and other related telecommunications equipment that are located throughout the world. IP networks transmit data (including voice and video data) by placing the data in packets and sending each packet individually to the selected destination, along one or more communication paths. Unlike a circuit-switched network (like PSTN 36b), a dedicated circuit is not required for the duration of a call or fax transmission over IP networks.

Technology that allows telecommunications to be transmitted over an IP network may comprise Voice over IP (VoIP), or simply Voice over Packet (VoP). In the illustrated embodiment, endpoint 32d, ACDs 34a-34b, and gateway 38 are IP telephony devices capable of participating in IM, video, and other multimedia communication sessions. IP telephony devices have the ability of encapsulating a user's voice (or other input) into IP packets so that the voice can be transmitted over network 36a. IP telephony devices may include telephones, fax machines, computers running telephony software, nodes, gateways, wired or wireless devices, hand held PDA, or any other device capable of performing telephony functions over an IP network.

In particular embodiments, communication system 30 may receive and transmit data in a session initiation protocol (SIP) environment. SIP is an application-layer control protocol that includes primitives for establishing, modifying and terminating communication sessions. SIP works independently of underlying transport protocols and without dependency on the type of session that is being established. SIP also transparently supports name mapping and redirection services, which support personal mobility.

It will be recognized by those of ordinary skill in the art that endpoints 32a-32d, ACDs 34a-34d and/or gateway 38 may be any combination of hardware, software, and/or encoded logic that provides communication services to a user. It will also be recognized that endpoints 32a-32d may be multimedia enabled with a set of multi-media capabilities. For example, endpoints 32a-32d may be capable of including a telephone, a computer running telephony software, a video monitor, a camera, an IP phone, a cell phone, IM client, short message service (SMS) client or any other communication hardware, software and/or encoded logic that supports the communication of packets of media (or frames) using communication network 36a. Endpoints 32a-32d may also include unattended or automated systems, gateways, other intermediate components or other devices that can establish media sessions. Although FIG. 1 illustrates a particular number and configuration of endpoints, ACDs, segments, nodes, and gateways, communication system 30 contemplates any number or arrangement of such components for communicating media.

FIG. 2 illustrates ACD 34a in more detail, in accordance with a particular embodiment of the present invention. In the illustrated embodiment, ACD 34a includes a call manager 42, an interface or input ports 44, a processor 46, a memory module 50, queues 54, a distributor 56, a graphical user interface (GUI) 58, and a feedback manager 60. Interface or input ports 44 couple ACD 34a with communication network 36a. Processor 46 may be a microprocessor, controller, or any other suitable computing device, resource, or combination of hardware, software and/or encoded logic. Memory module 50 may be any form of volatile or non-volatile memory including, without limitation, magnetic media, optical media, random access memory (RAM), read-only memory (ROM), removable media, or any other suitable local or remote memory component.

GUI 58 presents information to agents 48 and other users of ACD 34a. In particular embodiments, GUI 58 may present information to agents through their respective endpoints 49a-49d. In some embodiments, information may be presented through one or more electronic bulletin boards within sight of the agents. Any suitable information may be presented by GUI 58, such as information to help increase the efficiency of ACD 34a and its users and agents.

The illustrated embodiment includes agents 48, caller 62, and endpoints 49. Agents 48a-48d may use endpoints 49a-49d to communicate with caller 62 through ACD 34a. Caller 62 may use endpoints 49e and 49f to communicate with ACD 34a (and feedback manager 60). Caller 62 may use endpoints 49e and 49f to request communication with agents 48 and/or feedback manager 60. In particular embodiments, caller 62 may communicate with agents 48 and feedback manager 60 in parallel communication sessions. Endpoints 49a-49f may be similar to one or more of the endpoints 32a-32d described above with respect to FIG. 1, such as IP phone endpoint 32d. Endpoints 49e and 49f may have an IM client or SMS client embedded within them. It should be understood that endpoints 49 may be coupled to ACD 34a through one or more communication networks, such as the communication networks described above with respect to FIG. 1 which may include one or more WANs or LANs as indicated above. It should also be understood that ACDs in accordance with various embodiments may be associated with any suitable number of agents 48, callers 62, and endpoints 49.

Call manager 42 maintains information on agents and other users of communication system 30 and facilitates communication among users. Call manager 42 may be any combination of hardware, software, and/or encoded logic and is used by ACD 34a to manage agents 48 and other users of communication system 30. In particular embodiments, call manager 42 may maintain a listing, table, or other organization of information about agents 48 and other users of system 30. The information may include a name or other identifier for each agent 48 and other user. The information may also include contact information such as phone numbers and email addresses for the agents 48 and users. For identifying agents 48a-48d that may be contacted or otherwise recruited to handle incoming calls received by the ACD 34a, call manager 42 may also include information identifying whether a user of system 30 is a call agent or performs other tasks within the organization. As is the case with other components of ACD 34a, in particular embodiments the functionality of call manager 42 may be performed by hardware, software or encoded logic distributed throughout a communication network coupled with the ACD.

Feedback manager 60 may include any combination of hardware, software, and/or encoded logic which is operable to receive, process, and/or respond to feedback from callers 62 and other users of the system. In certain embodiments, feedback manager 60 may be located within ACD 34a while in other embodiments feedback manager 60 may be distributed throughout communication system 30. In particular embodiments, feedback manager 60 may maintain a listing, table, or other organization of information about callers, agents, and other users of system. The information may include a name or other identifier for each agent, caller, and other user of the system. The information may also include contact information such as phone numbers and email addresses for agents 48, callers 62, and other users of the system. For identifying agents 48 that may be contacted based on their performance, feedback manager 60 may also maintain contact information identifying whether a user of system is an agent or performs other tasks within the organization. ACD 34a may also manage and track the communication sessions and the status of agents 48 such as logged on/off, on a call, or away from position.

As is the case with other components of ACD 34a, in particular embodiments the functionality of feedback manager 60 may be performed by hardware, software or encoded logic distributed throughout a communication network coupled with ACD 34a. Feedback may be transmitted to feedback manager 60 using audio and/or video means, including signals, data or messages transmitted through voice devices, text chat, web sessions, facsimile, instant messaging (IM), in-band or out-of-band dual-tone multi-frequency (DTMF) signals, e-mail, and other suitable communication method. In particular embodiments, feedback may include any combination of positive, negative, or neutral information sent by a caller 62 or other user regarding system performance, agent performance, or other parameters of customer satisfaction. Feedback may be received through any suitable manner, such as through IM, short message service (SMS), e-mail, in in-band or out-of-band DTMF signals, or soft keys. In particular embodiments, the system may utilize Web forms and/or IM sessions to collect feedback. Feedback manager 60 may use the collected feedback to change the ACD system in an effort to improve customer satisfaction and meet service level goals.

When an incoming call is received by processor 46, processor 46 determines if a suitable agent 48 is available to receive the call. If a suitable agent is available to receive the incoming call, distributor 56 may distribute the call to such agent for handling. For example, distributor 56 may connect a voice or video call with the available suitable agent. If a suitable agent is not available, the call may be placed into a queue 54 in order to wait for a suitable agent(s). In this embodiment, ACD 34a has two queues 54; however other embodiments of the present invention may have none, one or more than two queues 54. The selection of which queue 54 to place an incoming call may depend on the type of customer making the call, the type of service requested in the call or any other characteristic or condition relating to the call or to ACD 34a. While a customer is waiting for an agent, ACD 34a may perform one or more of several functions including feedback or other data collection from the user, playing of pre-recorded messages, or other automated process.

As soon as a suitable agent becomes available, the ACD system 34a may place the call in a queue and after a self service session, distributor 56 may distribute the call to an available agent. As caller 62, and for example agent 48a, start their first communication session, ACD system 34a may initiate a parallel second communication session between the caller 62 and feedback manager 60. In some cases, the second communication session may be a feedback session. In particular embodiments, the communication sessions may be conducted through more than one endpoint (e.g., endpoints 49e and 49f). In one example, the first communication session between agent 48a and caller 62 may be conducted through a first endpoint such as a phone and the second communication session between caller 62 and feedback manager 60 may be conducted through a second endpoint such as a computer. In this example, agent 48a may not be aware of the second communication session between caller 62 and feedback manager 60. It should be understood that ACDs in accordance with various embodiments may conduct any number of communication sessions with the caller 62. It should also be understood that communication sessions in accordance with various embodiments may be conducted in any suitable manner, such as through IM, short message service (SMS), e-mail, web form sharing, phone, in-band or out-of-band DTMF signals, or soft keys.

In particular embodiments, the feedback session may include a whisper session between feedback manager 60 and caller 62. In a whisper session, only the parties communicating through whispers may be aware of the whisper session. In one embodiment, feedback manager 60 may prompt caller 62 for feedback by voice whispering a feedback request through a first endpoint such as a phone. In this embodiment, agent 48a may not be aware of the whisper session. Caller 62 may respond to the whispered prompt from feedback manager 60 in any suitable manner. In one example, caller 62 may provide feedback back to feedback manager 60 through DTMF signals issued by depressing phone buttons.

In the illustrated example, the parallel communication sessions with caller 62 are conducted through two endpoints 49e and 49f. ACD system 34a initiates a first communication session between caller 62 and agent 48a over communication link 64 through endpoint 49e. As the first communication session is initiated, ACD system 34a initiates a parallel session between feedback manager 60 and caller 62. This parallel session is conducted over communication link 68 through endpoint 49f. In this example, caller 62 is communicating with agent 48a through endpoint 49e and is also communicating with feedback manager 60 through endpoint 49f (e.g., a computer). It should be understood that the communication sessions in accordance with various embodiments may be conducted through any suitable number of endpoints. For example, in one embodiment caller 62 may communicated with feedback manager 60 over communication link 66 with the same endpoint used to communicate with the agent, endpoint 49e.

In particular embodiments, when an incoming call is received, ACD system 34a may first detect whether one or more endpoints (e.g., endpoints 49e and 49f) of caller 62 are multi-media enabled. If the endpoints are multi-media enabled, ACD system 34a may determine a set of multi-media capabilities of the endpoints. Communication sessions may then be initiated using this determined set of multi-media capabilities of the endpoints. In one example, endpoint 49e may be a session initiation protocol (SIP) endpoint. In this example, the multi-media capabilities of SIP endpoint 49e may be determined during SIP session negotiation. Any suitable telephonic user interface (TUI) may be used depending on the phone capabilities detected during session negotiation. The system application may either be initiated by an XML script delivered with the SIP signaling and/or by calling a URL to the application delivered during the negotiation. The results of the communication sessions may be delivered though HTTP, IM or any suitable transport or application protocol.

In particular embodiments, all communication between the parties in the communication sessions may be recorded to provide the contact center with better feedback granularity about the quality of service that the agent provided throughout the interaction. In one example, ACD system 34a may make an audio recording of the telephonic communications occurring between caller 62 and agent 48a during a particular call. If the contact center reviews the recording and finds that agent 48a handled two topics during the call, the first one with mixed reviews and the second one exceedingly well, the recording may distinguish the performance on each topic. In this case, rather than getting one score for the overall satisfaction of the call, each call topic may receive a score. This may help the contact center coach agent 48a on the first topic and increase the level of customer satisfaction. In certain cases, the call center may choose to route calls concerning the second topic to this particular agent 48a in the future.

In particular embodiments, ACD system 34a may take steps to avoid directing a caller to an agent who performed poorly in a previous session with the same caller. After the call is received for connection to a suitable agent, an agent such as agent 48a may be selected from the plurality of agents. It may then be determined whether caller 62 and agent 48a communicated during a previous communication session and whether there is a feedback record from that previous session. The feedback record may include recordings, scores, ratings, or any other data that indicates the level of customer satisfaction. If the feedback record from the previous session fell below a predetermined satisfaction threshold, an alternate agent such as agent 48b may be selected and the call may be distributed to alternate agent 48b. In this way, ACD system 34a can avoid distributing calls to agents who have received low customer satisfaction ratings from callers in the past.

In particular embodiments, agents may be rated or scored based on feedback regarding their ability to address certain types of issues, answer particular questions, or help specific types of customers. In some cases, feedback scores may be stored in the caller's profile. In other cases, the feedback scores may be stored in the agent's profile. Feedback scores may be used as a routing metric when the caller calls in again. For example, if caller 62 gave really low marks to agent 48c during a previous session, ACD system 34a might decide not to route caller 62 to agent 48c when caller 62 calls in again. In one embodiment, calls may be distributed only to those agents that are highly rated in handling the caller's issue. For example, if agent 48d is highly rated in handling defective washing machine issues, ACD system 34a may distribute calls regarding defective washing machines to agent 48d when possible. In some embodiments, feedbacks are processed continuously/dynamically with minimal allowable delay as a score per agent and used immediately in routing calls to those agents. For example, each call is routed to the currently available agent with the highest score. This will reward agents with higher scores with more calls (and potentially higher commission/bonus) as well as resulting in a better customer service for callers.

In certain embodiments, ACD system 34a may present caller 62 with a feedback form. Caller 62 may rate for example, agent 48a and the call via the form. In particular embodiments, the form is a JavaServer Page (JSP) which calculates a feedback score while the call is ongoing. The JSP based form automatically and continuously calculates the caller's satisfaction score and compares it to a pre-determined threshold. If the score falls bellow the threshold, ACD system 34a may create a notification event. In some cases, a supervisor may be notified of the event. The notification may trigger the supervisor to start monitoring the session between caller 62 and agent 48a or trigger recording of both communication sessions. In one embodiment, if the caller's satisfaction score falls below the pre-determined threshold, the first communication session may be intercepted by a supervisor. In another embodiment, if the caller's satisfaction score falls below the pre-determined threshold, the call may be transferred to another agent or to a supervisor.

In particular embodiments, other metrics may be used in conjunction with the feedback to determine whether action is needed. In some cases, ACD system 34a may flag the call to be recorded based on voice metrics of the call, but if the feedback of the call is within the satisfaction threshold, the supervisor may decide not to intercept the call, hence saving call center resources.

It will be recognized by those of ordinary skill in the art that ACD 34a is merely one example configuration of an ACD for handling calls in accordance with particular embodiments. ACD 34a may include any number of interfaces, call managers, feedback managers, processors, memory modules, distributors and queues to accomplish the functionality and features described herein. For example, although ACD 34a is illustrated and described as including call manager 42, interface 44, processor 46, memory module 50, two queues 54, distributor 56, GUI 58, and feedback manager 60, these components and other desired components for performing the above described functionality may be centrally located (local) with respect to one another, or distributed throughout communication system 30. In addition, one or more components of ACD 34a may work together in performing various functionality described herein.

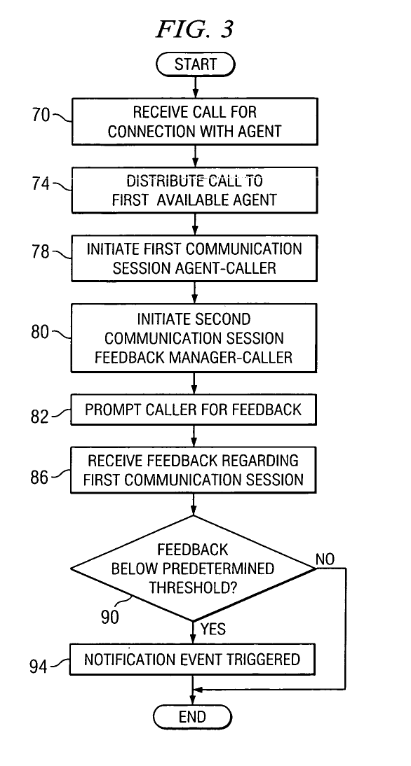

FIG. 3 illustrates a method for receiving feedback at an automatic call distribution system, in accordance with a particular embodiment. In particular embodiments, the automatic call distribution system may be located at a call center or other service center. The method begins at step 70 where a call is received for connection with an agent. The call may be received at an ACD system, such as the system including ACD 34a. At step 74, the call is distributed to a first agent to handle the call. This first agent may be selected by ACD 34a out of a plurality of agents associated with ACD 34a.

At step 78, a first communication is initiated between the first agent to handle the call and the caller. At step 80, a second communication session is initiated between the caller and the feedback manager, such as the feedback manager 60 in ACD 34a. The second communication session may be a feedback session. The feedback session may be parallel to the first communication session, for example, at least a portion of the feedback session may overlap with a portion of the first communication session. In some cases, the two communication sessions may be initiated at the same time. In some cases, the feedback session may be initiated with the same endpoint used by the caller to communicate with the agent, while in other cases the feedback session may be initiated with a different endpoint associated with the caller. In particular embodiments, the one or more of the communication sessions may be a web session or an IM session. In particular embodiments, the caller may have the option of participating in, ignoring, rejecting, or closing the first communication session and/or second communication session.

At step 82, caller 62 is prompted for feedback concerning the first communication session between caller 62 and the agent. For example, the customer may be asked “Is the agent courteous?”, “Does the agent have the information or know-how to help you?”, or “Are you pleased by the way the call is progressing?” In some cases, the caller may be prompted for feedback requesting to be switched to a new agent. For example, the caller may be asked “Do you want to speak to another agent?” If the caller answers affirmatively, the call may be transferred to another agent selected from the plurality of agents. The caller may be prompted to provide feedback through any suitable method, such as through his respective endpoint. In some embodiments, the caller may be prompted at another associated endpoint, such as a computer. Some embodiments may use a whisper feature, feedback form, special graphical user interface (GUI), instant message or email to prompt the caller. In particular embodiments, the user may be presented with a feedback form. The caller may then rate customer satisfaction during the ongoing call via the form. In one particular embodiment, the form may be a JSP with dynamic web content that calculates a feedback score during the ongoing call. In some embodiments, the caller may only have the ability to reply with “yes” or “no” when prompted to reply with whether the caller is satisfied with the way the call is progressing. In some cases, the caller may be able to enter additional information. The input or feedback from the caller may be taken into consideration and embedded into the performance scoring discussed herein. Feedback may be received from an endpoint separate than the one being used on the call.

At step 86, feedback is received from the caller regarding the handling of the first communication session. This feedback may include, for example, an indication from the caller of how pleased the caller is with the call, a rating of the agent's performance, or other indication of customer satisfaction. In some cases, the feedback manager may process the received feedback to determine whether any action should be taken. If, for example, the feedback manager determines that the caller is dissatisfied with the agent's performance in the first session, a notification event may be triggered. Feedback may also be received from a second endpoint separate from the endpoint being used on the call. For example, during a phone call between the caller and the agent, the feedback manager may receive feedback from the caller through a personal digital assistant.

At step 90, it is determined whether the feedback is below a predetermined threshold. The predetermined threshold may be based on service level goals. The service level goals may comprise any goal or target to which an ACD system may be committed, such as answering, distributing, and/or completing a certain percentage of incoming calls within an allowable level of customer satisfaction.

If it is determined that the feedback is below a predetermined satisfaction threshold, then at step 94 a notification event is triggered. The notification event may notify the supervisor, feedback manager 60, or other participant that the feedback falls below a predetermined satisfaction threshold and that some action may be necessary to remedy the performance issue. In one embodiment, the system acts by transferring the call from the agent to the supervisor. In another embodiment, the system may initiate a third session between the supervisor and the caller to monitor the call. If the supervisor determines that intervention is necessary, the supervisor may intercept the first session. The first session between the agent and the caller may be recorded for evaluation purposes. The performance of the agent or the system may then be scored based on the feedback and the score included in the feedback record or the caller's profile.

Some of the steps illustrated in FIG. 3 may be combined, modified or deleted where appropriate, and additional steps may also be added to the flowchart in FIG. 3. Additionally, steps may be performed in any suitable order without departing from the scope of the invention.

Although the present invention has been described in detail with reference to particular embodiments, it should be understood that various other changes, substitutions, and alterations may be made hereto without departing from the spirit and scope of the present invention. For example, although the present invention has been described with reference to a number of elements included within communication system 30 and ACD 34a, such as feedback manager 60, these elements may be combined, rearranged or positioned in order to accommodate particular routing architectures or needs. In addition, any of these elements may be provided as separate external components to communication system 30, ACD 34a or each other where appropriate. The present invention contemplates great flexibility in the arrangement of these elements as well as their internal components.

It should be understood that the architecture and functionality of ACDs and call centers described above is applicable generally to all call or contact centers that operate to answer incoming calls, make outgoing calls, and identify appropriate agents to receive the calls. Accordingly, the described ACDs may include those call or contact centers that are located within an enterprise and are staffed by enterprise employees. ACDs implementing various functionality described herein are not intended to be limited to hosted and outsourced call or contact centers.

Numerous other changes, substitutions, variations, alterations and modifications may be ascertained by those skilled in the art and it is intended that the present invention encompass all such changes, substitutions, variations, alterations and modifications as falling within the spirit and scope of the appended claims.

What is claimed is:

1. A method for receiving call center feedback, comprising:
receiving a call from a caller for connection with one of a plurality of agents;
distributing the call to a first agent of the plurality of agents;
initiating a first communication session with the caller and the first agent to handle the call;
initiating a second communication session with the caller, the second communication session comprising a feedback session parallel to the first communication session; and
receiving from the caller feedback relating to the first communication session between the caller and the first agent.

2. The method of claim 1, further comprising prompting the caller in the first communication session for the feedback.

3. The method of claim 1, further comprising:
detecting that an endpoint of the caller is multi-media enabled;
determining a set of multi-media capabilities of the endpoint; and
initiating the first communication session and the second communication session using multimedia connections compatible with the set of multi-media capabilities of the endpoint.

4. The method of claim 1,
wherein initiating a first communication session with the caller and the first agent to handle the call comprises initiating the first communication session at a first endpoint associated with the caller; and
wherein initiating a second communication session with the caller comprises initiating the second communication session at a second endpoint associated with the caller.

5. The method of claim 1, wherein the feedback session comprises a web session.

6. The method of claim 1, wherein the feedback session comprises an instant messaging session.

7. The method of claim 1,
wherein the feedback session comprises a voice whisper session; and
further comprising:
whispering prompts to the caller; and
receiving from the caller via DTMF commands feedback communication in response to the prompts.

8. The method of claim 1, further comprising determining that the received feedback falls below a predetermined satisfaction threshold.

9. The method of claim 8, further comprising, in response to the determining that the received feedback falls below a predetermined satisfaction threshold, notifying a supervisor that the received feedback falls below the predetermined satisfaction threshold.

10. The method of claim 8, further comprising, in response to the determining that the received feedback falls below a predetermined satisfaction threshold, initiating a communication session with a supervisor to monitor the call.

11. The method of claim 8, further comprising, in response to the determining that the received feedback falls below a predetermined satisfaction threshold, transferring the call from the first agent to a supervisor.

12. The method of claim 8, further comprising, in response to the determining that the received feedback falls below a predetermined satisfaction threshold, recording the first session for evaluation.

13. The method of claim 1, wherein the distributing the call to a first agent of the plurality of agents comprises:
selecting a second agent from the plurality of agents;
determining that the caller and the second agent communicated during a previous communication session with a feedback record;
determining that the feedback record of the previous communication session fell below a predetermined satisfaction threshold;
selecting the first agent from the plurality of agents; and
distributing the call to the first agent of the plurality of agents.

14. The method of claim 1, further comprising, sending the feedback relating to the first communication session to the first agent.

15. The method of claim 1, wherein the distributing the call to a first agent of the plurality of agents comprises:
calculating a plurality of scores, a score corresponding to each agent of the plurality of agents;
selecting the first agent from the plurality of agents, the first agent having a highest score of the plurality of scores; and
distributing the call to the first agent of the plurality of agents.

16. A system for receiving call center feedback, comprising:
an interface operable to receive a call from a caller for connection with one of a plurality of agents;
a processor operable to:
distribute the call to a first agent of the plurality of agents;
initiate a first communication session with the caller and a first agent to handle the call; and
initiate a second communication session with the caller, the second communication session comprising a feedback session parallel to the first communication session; and
the interface further operable to receive from the caller feedback relating to the first communication session between the caller and the first agent.

17. The system of claim 16, wherein the processor is further operable to prompt the caller in the first communication session for the feedback.

18. The system of claim 16, wherein the processor is further operable to:
detect that an endpoint of the caller is multi-media enabled;
determine a set of multi-media capabilities of the endpoint; and
initiate the first communication session and the second communication session using multimedia connections compatible with the set of multi-media capabilities of the endpoint.

19. The system of claim 16, wherein:
a processor operable to initiate a first communication session comprises a processor operable to initiate the first communication session at a first endpoint associated with the caller; and
a processor operable to initiate a second communication session comprises a processor operable to initiate the second communication session at a second endpoint associated with the caller.

20. The system of claim 16, wherein the feedback session comprises a web session.

21. The system of claim 16, wherein the feedback session comprises an instant messaging session.

22. The system of claim 16, wherein:
the feedback session comprises a voice whisper session; and
the interface is further operable to:
whisper prompts to the caller; and
receive from the caller via DTMF commands feedback communication in response to the prompts.

23. The system of claim 16, wherein the processor is further operable to determine that the received feedback falls below a predetermined satisfaction threshold.

24. The system of claim 23, wherein the processor is further operable to, in response to the determining that the received feedback falls below a predetermined satisfaction threshold, notify a supervisor that the received feedback falls below the predetermined satisfaction threshold.

25. The system of claim 23, wherein the processor is further operable to, in response to the determining that the received feedback falls below a predetermined satisfaction threshold, initiate a communication session with a supervisor to monitor the call.

26. The system of claim 23, wherein the processor is further operable to, in response to the determining that the received feedback falls below a predetermined satisfaction threshold, transfer the call from the first agent to a supervisor.

27. The system of claim 23, wherein the processor is further operable to, in response to the determining that the received feedback falls below a predetermined satisfaction threshold, record the first session for evaluation.

28. The system of claim 16, wherein:
a processor operable to distribute the call to a first agent of the plurality of agents comprises a processor operable to:
select a second agent from the plurality of agents;
determine that the caller and the second agent communicated during a previous communication session with a feedback record;
determine that the feedback record of the previous communication session fell below a predetermined satisfaction threshold;
select the first agent from the plurality of agents; and
distribute the call to the first agent of the plurality of agents.

29. The system of claim 16, wherein the interface is further operable to send the feedback relating to the first communication session to the first agent.

30. The system of claim 16, wherein a processor operable to distribute the call to a first agent of the plurality of agents comprises a processor operable to:
calculate a plurality of scores, a score corresponding to each agent of the plurality of agents;
select the first agent from the plurality of agents, the first agent having a highest score of the plurality of scores; and
distribute the call to the first agent of the plurality of agents.

31. Logic embodied in a computer readable medium, the computer readable medium comprising code operable to:
receive a call from a caller for connection with one of a plurality of agents;
distribute the call to a first agent of the plurality of agents;
initiate a first communication session with the caller and the first agent to handle the call;
initiate a second communication session with the caller, the second communication session comprising a feedback session parallel to the first communication session; and
receive from the caller feedback relating to the first communication session between the caller and the first agent.

32. The medium of claim 31, wherein the code is further operable to prompt the caller in the first communication session for the feedback.

33. The medium of claim 31, wherein the code is further operable to:
detect that an endpoint of the caller is multi-media enabled;
determine a set of multi-media capabilities of the endpoint; and
initiate the first communication session and the second communication session using multimedia connections compatible with the set of multi-media capabilities of the endpoint.

34. The medium of claim 31, wherein:
code operable to initiate a first communication session comprises code operable to initiate the first communication session at a first endpoint associated with the caller; and
code operable to initiate a second communication session comprises code operable to initiate the second communication session at a second endpoint associated with the caller.

35. The medium of claim 31, wherein the code is further operable to determine that the received feedback falls below a predetermined satisfaction threshold.

36. The medium of claim 31, wherein the code is further operable to, in response to determining that the received feedback falls below a predetermined satisfaction threshold, notify a supervisor that the received feedback falls below the predetermined satisfaction threshold.

37. A system of receiving call center feedback, comprising:
means for receiving a call from a caller for connection with one of a plurality of agents;
means for distributing the call to a first agent of the plurality of agents;
means for initiating a first communication session with the caller and the first agent to handle the call;
means for initiating a second communication session with the caller, the second communication session comprising a feedback session parallel to the first communication session; and
means for receiving from the caller feedback relating to the first communication session between the caller and the first agent.

38. A method for receiving call center feedback, comprising:
receiving a call from a caller for connection with one of a plurality of agents;
detecting that an endpoint of the caller is multi-media enabled;
determining a set of multi-media capabilities of the endpoint;
distributing the call to a first agent of the plurality of agents;
initiating a first communication session with the caller and the first agent to handle the call, the first communication session initiated using multimedia connections compatible with the set of multi-media capabilities of the endpoint;
initiating a second communication session with the caller, the second communication session comprising a feedback session parallel to the first communication session, the second communication session initiated using multimedia connections compatible with the set of multi-media capabilities of the endpoint;
prompting the caller in the first communication session for feedback;
receiving from the caller feedback relating to the first communication session between the caller and the first agent; and
determining that the received feedback falls below a predetermined satisfaction threshold.
